(19) United States
(12) Patent Application Publication
(10) Pub. No.: US 2006/0221217 A1
(43) Pub. Date: Oct. 5, 2006

(54) Image taking apparatus and digital camera

(75) Inventors: Hiroaki Kubo, Muko-shi (JP); Tsutomu Honda, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/371,670

(22) Filed: Mar. 9, 2006

(30) Foreign Application Priority Data
Mar. 16, 2005 (JP) 2005-75109

(51) Int. Cl. H04N 9/09

(52) U.S. Cl. 348/262

(57) ABSTRACT

An image taking apparatus having a first sensor configured to photoelectrically convert a subject image for outputting an image data, a second sensor configured to photoelectrically convert the subject image formed on the first sensor for outputting a photoelectric conversion signal, said second sensor having at least two photoelectric conversion areas that output the photoelectric conversion signal, an image processor configured to process the image data from the first sensor with a predetermined input and output characteristic, and a controller configured to set the input and output characteristic of the image processor based on dispersion information of a subject luminance distribution obtained from the photoelectric conversion signal from the second sensor.

### CROSS-REFERENCE TO RELATED APPLICATION

This application is based on Japanese Patent Application No. 2005-75109 filed in Japan on Mar. 16, 2005, the entire content of which is hereby incorporated by reference.

### BACKGROUND OF THE INVENTION

1. Field of the Invention

The present invention relates to an image taking apparatus and a digital camera. More specifically, the present invention relates to an image taking apparatus and a digital camera wherein a photoelectric conversion signal of a sensor is obtained before image taking and the setting of image processing means is performed.

2. Description of the Related Art

It is known that in image taking apparatuses such as digital cameras, in order that image reproduction closer to the actual subject can be performed, the image processing setting (for example, the gamma correction) of the taken image is changed based on the luminance distribution information of the subject obtained by analyzing the density pattern of the taken image or predicting the absolute luminance of the subject. However, although the actual luminance distribution of the subject is not less than the sixth power of 10 according to the situation, the dynamic range of the image sensor is, at most, 10 squared or cubed, and the luminance distribution of the subject cannot be measured from a single taken image.

Examples of the method of measuring the luminance distribution of the subject with a wide dynamic range by use of the image sensor as described above include a method of predicting the luminance distribution of the subject from a plurality of pieces of image data obtained by performing image taking a plurality of times with different exposure amounts. For example, a method has conventionally been proposed such that preliminary light emission is performed a plurality of times by a strobe device, the reflected light is metered, the number of times of regular light emission and the exposure amount are automatically set according to the luminance distribution obtained from the result of the metering, exposure is performed a plurality of times, and the image data obtained thereby is gamma-corrected to perform image synthesis.

However, according to the conventionally proposed art, since it is necessary to perform preliminary light emission a plurality of times and perform exposure a plurality of times in regular exposure, the art can be applied only to limited image taking opportunities and subjects, and it is difficult to apply the art to opportunities that require to capture blink-of-an-eye occurrences like image taking of sport scenes.

In digital single-lens reflex cameras, since the semitransparent mirror is on the optical path to the image sensor in order to direct the subject light to the optical finder before image taking, image information cannot be obtained from the image sensor. For this reason, the art cannot be applied to digital single-lens reflex cameras.

### SUMMARY OF THE INVENTION

A principal object of the present invention is to provide an image taking apparatus with which the optimum taken image according to the luminance distribution of the subject is obtained.

Another object of the present invention is to provide an image taking apparatus with which the information on the luminance distribution of the subject is obtained in a short time and the optimum taken image data according to the luminance distribution of the subject is obtained.

The above-mentioned objects of the present invention are attained by providing an image taking apparatus comprising:

a first sensor configured to photoelectrically convert a subject image for outputting an image data;

a second sensor configured to photoelectrically convert the subject image formed on the first sensor for outputting a photoelectric conversion signal, said second sensor having at least two photoelectric conversion areas that output the photoelectric conversion signal;

an image processor configured to process the image data from the first sensor with a predetermined input and output characteristic; and

a controller configured to set the input and output characteristic of the image processor based on dispersion information of a subject luminance distribution obtained from the photoelectric conversion signal from the second sensor.

The above-mentioned objects of the present invention are also attained by providing a method for processing of an image data of a subject in an image taking apparatus, said method comprising the steps of:

photoelectrically converting a subject image and outputting the image data by a first sensor;

photoelectrically converting the subject image formed on the first sensor and outputting a photoelectric conversion signal by a second sensor, said second sensor having at least two photoelectric conversion areas that output the photoelectric conversion signal; and

processing the image data from the first sensor with a predetermined input and output characteristic that is set based on dispersion information of a subject luminance distribution obtained from the photoelectric conversion signal from the second sensor.

These and other objects, advantages and features of the invention will become apparent from the following description thereof taken in conjunction with the accompanying drawings, which illustrate specific embodiments of the invention.

### BRIEF DESCRIPTION FO DRAWINGS

These and other objects, advantages and features of the invention will become apparent from the following description thereof taken in conjunction with the accompanying drawings in which:

FIG. 1 is an external view of a digital camera 1 according to the present invention;

FIG. 2(a) is a cross-sectional view showing a condition where a flash 94 is accommodated in a camera body 2 in the digital camera 1 according to the present invention;

FIG. 2(b) is a cross-sectional view showing a flash light metering condition in the digital camera 1 according to the present invention;

FIG. 2(c) is a cross-sectional view showing a condition during image taking in the digital camera 1 according to the present invention;

FIG. 3 is a functional block diagram of the digital camera 1 according to the present invention;

FIG. 4(a) is an explanatory view of an automatic focusing control optical system in the digital camera 1 according to the present invention;

FIG. 4(b) is an explanatory view of the principle of the phase difference detection method in the digital camera 1 according to the present invention;

FIG. 5 is a view explaining an example of the distance measurement pattern of a distance measurement sensor 42;

FIG. 6 is a view explaining an example of the metering pattern of a metering sensor 41 and a flash light amount metering sensor 43;

FIG. 7 is a flowchart explaining the setting procedure of the image processing performed by the image taking apparatus according to the present invention;

FIG. 8(a) is a view explaining an example of the data obtained when the dispersion σ² of the subject luminance distribution obtained by the sensor according to the present invention is low;

FIG. 8(b) is a view explaining an example of the data obtained when the dispersion σ² of the subject luminance distribution obtained by the sensor according to the present invention is high;

FIG. 9(a) is a view explaining an example of the gradation conversion characteristic applied when the dispersion of the luminance distribution of the subject is low as shown in FIG. 8(a);

FIG. 9(b) is a view explaining an example of the gradation conversion characteristic applied when the dispersion of the luminance distribution of the subject is high as shown in FIG. 8(b);

FIG. 10(a) is a view explaining an example of the frequency response characteristic applied when the dispersion of the luminance distribution of the subject is low as shown in FIG. 8(a); and

FIG. 10(b) is a view explaining an example of the frequency response characteristic applied when the dispersion of the luminance distribution of the subject is high as shown in FIG. 8(b).

### DESCRIPTION OF THE PREFERRED EMBODIMENT

Hereinafter, an embodiment of the present invention will be described with reference to the drawings.

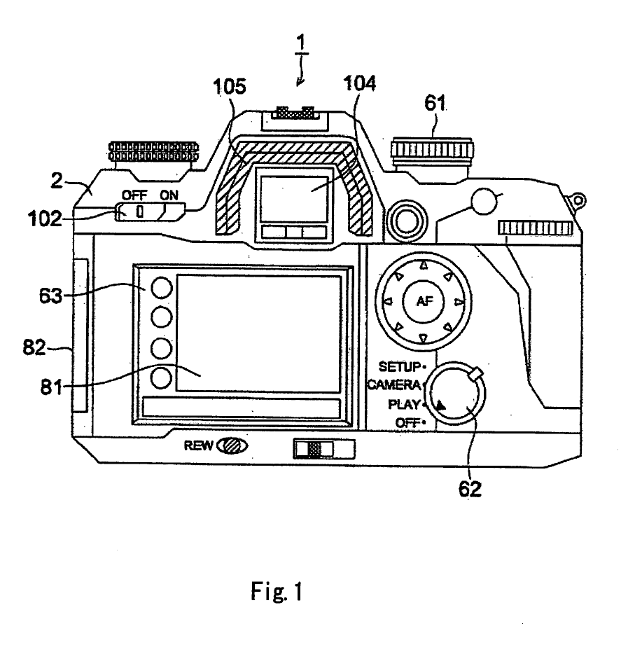

FIG. 1 is an external rear view briefly showing the structure of a digital camera 1 which is an embodiment to which the image taking apparatus according to the present invention is applied.

A shutter button 61 is provided on the top surface of a camera body 2. A power switch 102, a liquid crystal monitor 81, a mode switch 62, a display switching button 63, a finder ocular portion 105 and a memory card lid 82 are provided on the rear surface of the camera body 2.

The mode switch 62 is for switching among a recording mode, a playback mode and a setup mode. The recording (camera) mode is for performing image taking. The playback mode is for playing back taken images recorded on a memory card 25, on the liquid crystal monitor 81. The setup mode is for performing the setting of the recording mode and the playback mode.

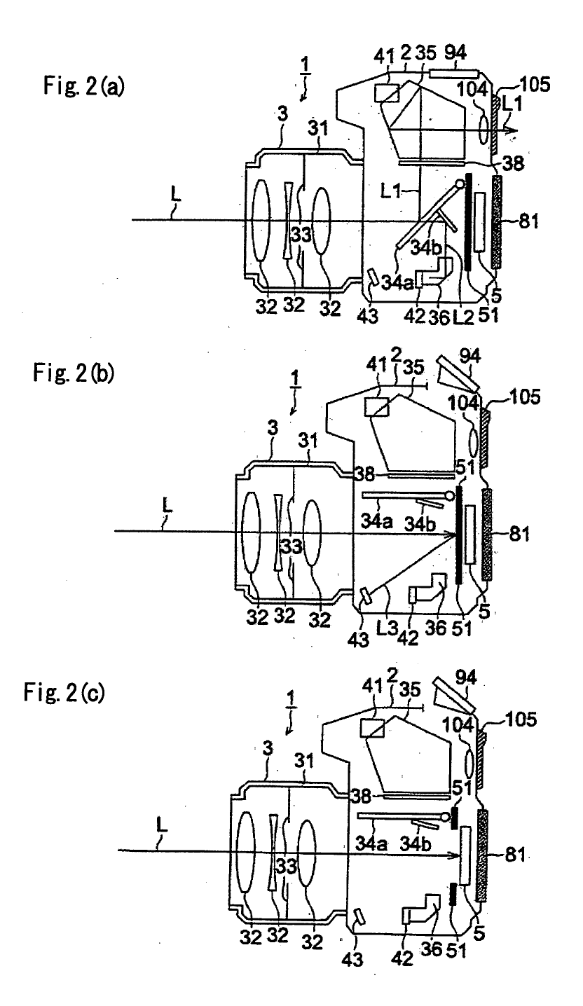

The internal structure of the digital camera 1 shown in FIG. 1 will be described with reference to FIGS. 2(a) to 2(c). FIGS. 2(a), 2(b) and 2(c) are cross-sectional views of the digital camera 1 of FIG. 1 viewed from a side. FIG. 2(a) shows a condition before image taking. FIG. 2(b) shows a flash light metering condition. FIG. 2(c) shows a condition during image taking.

The digital camera 1 is a lens-interchangeable, so-called digital single-lens reflex camera, and mainly includes the camera body 2 and a taking lens 3 coupled to the camera body 2.

The taking lens 3 mainly includes a lens barrel 31, a plurality of lens units 32 provided in the lens barrel 31, and a diaphragm 33. Most of the light incident along the optical axis L of the lens units 32 is perpendicularly bent upward (upward on the plane of the figure) at 90 degrees by a first mirror 34a, and formed into an image on a focusing screen 38. The formed light image is reflected twice inside a pentaprism 35 so that the user views the subject image through an eyepiece 104. A metering sensor 41 provided above the pentaprism 35 is provided for metering the subject image formed on the focusing screen 38, obtaining the (dispersion) information of the luminance distribution of the subject and performing automatic exposure. The structure of the metering sensor 41 will be described later.

On the other hand, part of the light incident along the optical axis L of the lens units 32 passes through the first mirror 34a which is a semitransparent mirror, and is incident on a second mirror 34b. The incident light is perpendicularly bent downward (downward on the plane of the figure) at 90 degrees by the second mirror 34b to constitute an optical axis L2, is incident on an AF sensor optical unit 36, and is formed into an image on a distance measurement sensor 42. The structure of the distance measurement sensor 42 will be described later.

FIG. 2(a) shows a condition where a flash 94 is accommodated in the camera body 2. FIGS. 2(b) and 2(c) show conditions where the light emitting portion of the flash 94 pops up from the camera body 2 so that light can be emitted toward the subject.

Next, the flash light metering condition will be described with reference to FIG. 2(b).

In flash image taking, prior to flash image taking, the flash 94 is preliminarily fired, the reflected light from the subject is metered, and the light amount for regular light emission is set. In FIG. 2(b), for the flash light metering, the first mirror 34a and the second mirror 34b are retracted from the optical axis L by a non-illustrated mirror driving mechanism, and accommodated in an upper part of the camera body 2. At this time, a shutter 51 is still closed.

When the flash 94 is fired in a predetermined light amount under this condition, the reflected light from the subject is incident through the lens units 32, reflected at the surface of the shutter 51 (optical axis L3), and formed into an image on a flash light amount metering sensor 43.

The structure of the flash light amount metering sensor 43 will be described later.

Next, the condition during image taking will be described with reference to FIG. 2(c).

While the shutter 51 is completely closed so as to block the optical path before image taking in FIG. 2(a), when exposure is performed during image taking, the shutter 51 is opened upward and downward to release the optical path as shown in FIG. 2(c).

Under this condition, the light incident through the lens units 32 is formed into an image on a CCD (charge coupled device) 5 which is an example of the image sensor. In the present invention, the image sensor may be a solid-state image sensor such as a CMOS sensor or a CID sensor instead of the CCD. The video signal obtained by the CCD 5 is converted into a digital signal by a non-illustrated circuit board, undergoes an image processing, and is then recorded onto the memory card 25.

The taking lens 3 is structured as a zoom lens, and the focal length (image taking magnification) can be changed by changing the arrangement of the lens units 32.

The CCD 5 is an image sensor comprising fine pixels to each of which a color filter is provided, and photoelectrically converts the light image of the subject (subject image) formed by the taking lens 3 into image signals having color components of, for example, R, G and B. The light receiving surface of the CCD 5 is disposed so as to coincide with the image formation plane, and a partial area of the image formation plane including the image circle is obtained as image data (in this specification, sometimes referred to merely as “image”).

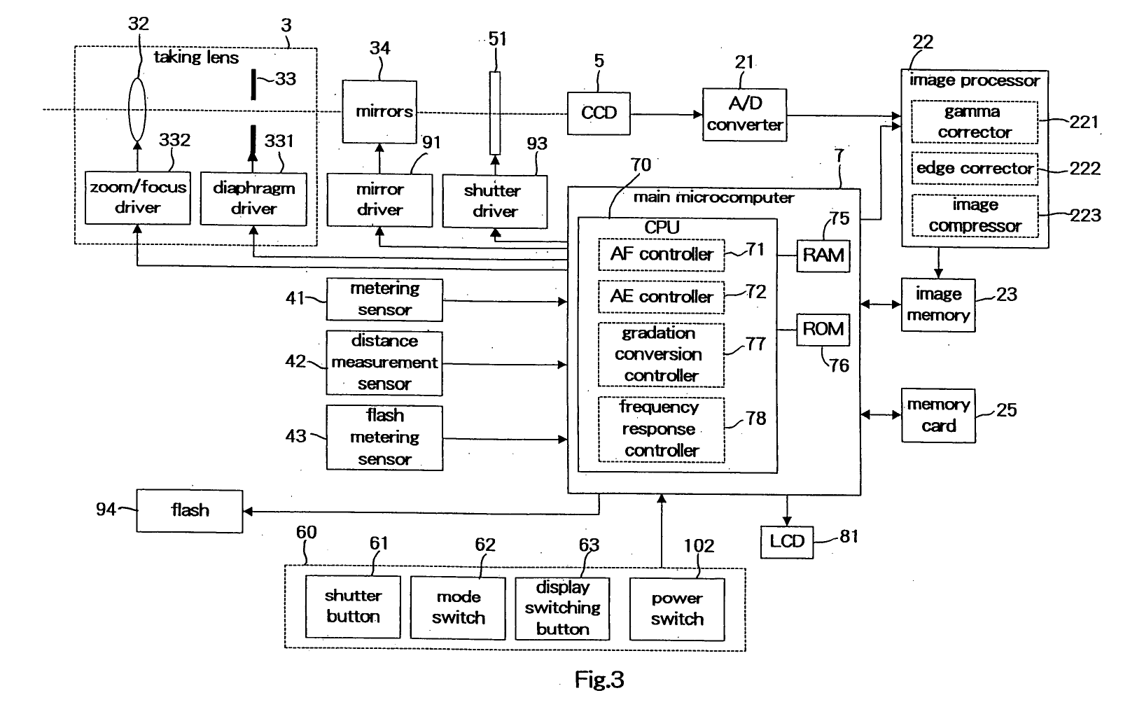

FIG. 3 is a block diagram showing principal functional components of the digital camera 1 of FIGS. 1 and 2(a) to 2(c). The same components as those shown in FIGS. 1 and 2(a) to 2(c) are denoted by the same reference numerals, and descriptions thereof are omitted.

The digital camera 1 includes an A/D converter 21, an image processor 22 as the image processing means of the present invention, an operation portion 60, a main microcomputer 7, and an image memory 23.

The main microcomputer 7 that functions as control means comprises a microcomputer. That is, the main microcomputer 7 has a CPU 70 performing various computations, a RAM 75 serving as the work area for performing the computations, and a ROM 76 storing control programs and the like, and collectively controls the operations of the processors of the digital camera 1. As the ROM 76 which is a nonvolatile memory, for example, an electrically rewritable EEPROM is adopted. Thereby, the ROM 76 is data-rewritable, and holds the contents of the data even when the power is off.

The outputs of the shutter button 61, the mode switch 62, the display switching button 63 and the power switch 102 of the operation portion 60 are inputted to the main microcomputer 70.

The operator (user) can perform various setting operations by performing predetermined operations on the operation portion 60.

For example, the operator can switch the mode of the digital camera 1 between the playback mode and the recording (camera) mode by operating the mode switch 62. Moreover, the operator can turn on and off the power with the power switch 102.

Moreover, the operator can switch the condition of the LCD 81 of the digital camera 1 between a display condition and a non-display condition by operating the display switching button 63.

A switch that is turned on by a half depression (S1) of the shutter button 61 and a switch that is turned on by a full depression (S2) of the shutter button 61 are interlocked with the shutter button 61 so that the CPU 70 can detect the timings of S1 and S2.

A mirror driver 91 drives the mirrors 34 (the first mirror 34a and the second mirror 34b) according to an instruction from the CPU 70 so as to retract from the optical path of the taking lens 3. A shutter driver 93 opens the shutter 51 upward and downward according to an instruction from the CPU 70 to release the optical path.

The A/D converter 21, the image processor 22 and the image memory 23 represent a processor that handles the images obtained by the CCD 5. That is, the images of analog signals obtained by the CCD 5 are converted into digital signals by the A/D converter 21.

The image processor 22 has image processing functions such as a gamma corrector 221, an edge corrector 222, and an image compressor 223. The set values of the correction amounts of the gamma corrector 221 and the edge corrector 222 are set according to instructions from a gradation conversion controller 77 and a frequency response controller 78 of the main microcomputer 7.

The gamma corrector 221 has a look-up table representing the gradation conversion characteristic which is an input and output characteristic, and has a function of converting the signal into a digital value corresponding to the inputted digital value and outputting it. That is, the gradation conversion controller 77 gradation-converts the digital signals converted by the A/D converter 21 with the gradation conversion characteristic set in the look-up table.

The edge corrector 222 corrects image edges and the like with a frequency response characteristic which is the input and output characteristic set by the frequency response controller 78, and temporarily stores it in the image memory 23.

The image compressor 223 compresses the digital signals having undergone the image processings, by the JPEG format or the like.

The distance measurement sensor 42 is a sensor used for automatic focusing control. The metering sensor 41 and the flash light amount metering sensor 43 are sensors used for automatic exposure control. The maim microcomputer 7 includes a non-illustrated A/D converter that converts the inputted output voltages of the sensors into digital values, and inputs them to the CPU 70.

The main microcomputer 7 has various control functions such as an automatic focusing controller (AF controller) 71, an automatic exposure controller (AE controller) 72, the gradation conversion controller 77, and a frequency response controller 78. The functions of the main microcomputer 7 are realized by the CPU 70 performing computations according to the control programs prestored in the ROM 76.

The main microcomputer 7 also has a control function of recording compressed images onto the memory card 25 or displaying them on the LCD 81 or the like. These processings on images are also performed based on the control by the main microcomputer 7.

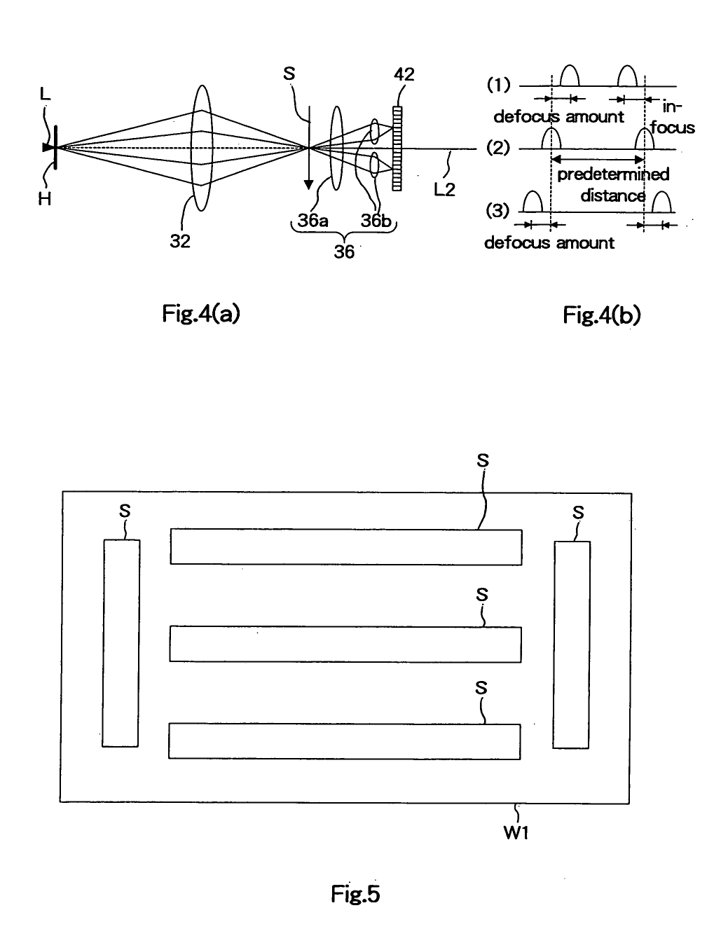

The AF controller 71 obtains a focusing evaluation value based on the luminance information of the subject (that is, the dispersion information of the subject luminance distribution) obtained from the photoelectric conversion signal from the distance measurement sensor 42 and adjusts the focus position of the taking lens 3 to thereby realize automatic focusing control. In the present embodiment, as an example of the structure performing automatic focusing control according to the phase difference detection method, the AF sensor optical unit 36 and the distance measurement sensor 42 will be described with reference to FIGS. 4(a) and 4(b).

FIG. 4(a) is a view for explaining an automatic focusing control optical system in the digital camera 1 according to the present invention.

The luminous flux from a subject H is formed into an image by the lens units 32 in the vicinity of an equivalent plane S of the image taking plane, and is incident on the AF sensor optical unit 36. The AF sensor optical unit 36 includes a condenser lens 36a and separator lenses 36b. The luminous flux having passed through the condenser lens 36a is formed into two images on the distance measurement sensor 42 on both sides (in the vertical direction of the plane of the figure) of the optical axis L2 by the two separator lenses 36b.

FIG. 4(b) is a view explaining the principle of the phase difference detection method.

(2) of FIG. 4(b) shows an in-focus state, and the two images are formed in positions a predetermined distance away from each other. When the subject H is near, as shown in (1) of FIG. 4(b), the two images are formed in positions a distance shorter than the predetermined distance away from each other. When the subject H is far, as shown in (3) of FIG. 4(b), the two images are formed in positions a distance longer than the predetermined distance away from each other. As described above, the focusing evaluation value can be obtained from the positions of the two images.

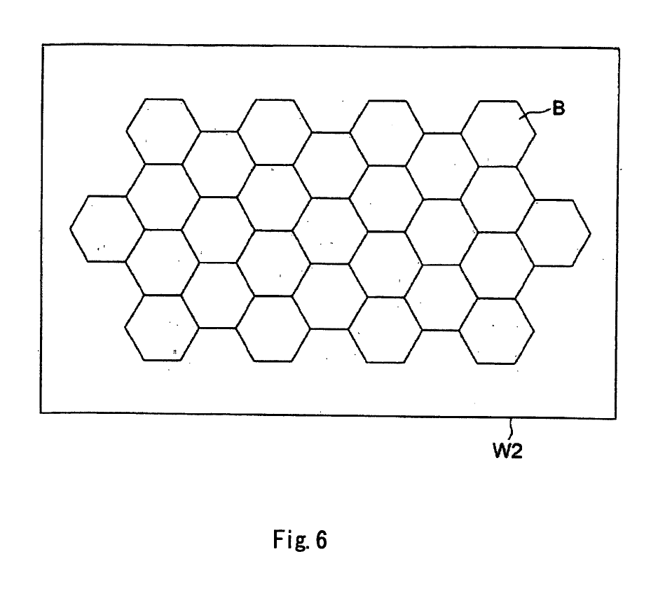

FIG. 5 is a view explaining an example of the distance measurement pattern of the distance measurement sensor 42.

An outer frame W1 represents the area of the subject image formed on the image sensor 5, that is, the image taking area (subject area). The rectangles within the outer frame are distance measurement areas S. The distance measurement sensor 42 is formed by arranging a combination of line-type solid-state image sensors according to the distance measurement areas S. The distance measurement sensor 42 may be formed of area sensors so that only the luminance information of the part corresponding to the distance measurement area is obtained from the outputs of the area sensors. As the distance measurement sensor 42, for example, a solid-state image sensor such as a CCD, a CMOS sensor or a CID sensor is used.

Since the CCD, for example, has a narrow dynamic range, automatic adjustment is made so that the output of the subject image is obtained by changing the exposure time by a non-illustrated driving circuit. From the exposure time and the output signal of the CCD, subject luminance information with a range wider than the dynamic range of the CCD can be obtained.

The taking lens 3 of FIG. 3 has a zoom and focus driver 332 and a diaphragm driver 331. The zoom and focus driver 332 drives lens elements included in the (focusing) lens units 32 in the direction of the optical axis as appropriate so that the focal length is the one set by the user and that the subject is in focus.

In the case of image taking by fixed light, the AE controller 72 calculates an AE evaluation value based on the representative luminance values of a plurality of metering blocks B obtained by the metering sensor 41 that photoelectrically converts the subject image divided into the metering blocks B, thereby realizing automatic exposure control.

The diaphragm driver 331 adjusts the aperture diameter of the diaphragm 33 so that the aperture value is the one set by the AE controller 72. The zoom and focus driver 332 and the diaphragm driver 331 are also electrically connected to the main microcomputer 7, and operate under the control of the main microcomputer 7.

In the case of image taking by flash light, similarly, the AE controller 72 calculates the AE evaluation value based on the representative luminance values of the metering blocks B obtained by the flash light amount metering sensor 43 photoelectrically converting the subject image divided into the metering blocks B, and controls the light emission amount of the flash 94, thereby realizing automatic exposure control.

FIG. 6 is a view explaining an example of the metering pattern of the metering sensor 41 and the flash light amount metering sensor 43. An outer frame W2 represents the area of the subject image formed on the image sensor 5, that is, the image taking area (subject area). The twenty-seven hexagons of FIG. 6 are the metering blocks B for metering the subject area being divided.

Since a photoelectric conversion element having a wide dynamic range such as a photodiode is disposed in each of the positions, of the metering sensor 41 and the flash light amount metering sensor 43, corresponding to the metering blocks B, the representative luminance values of the metering blocks B are obtained.

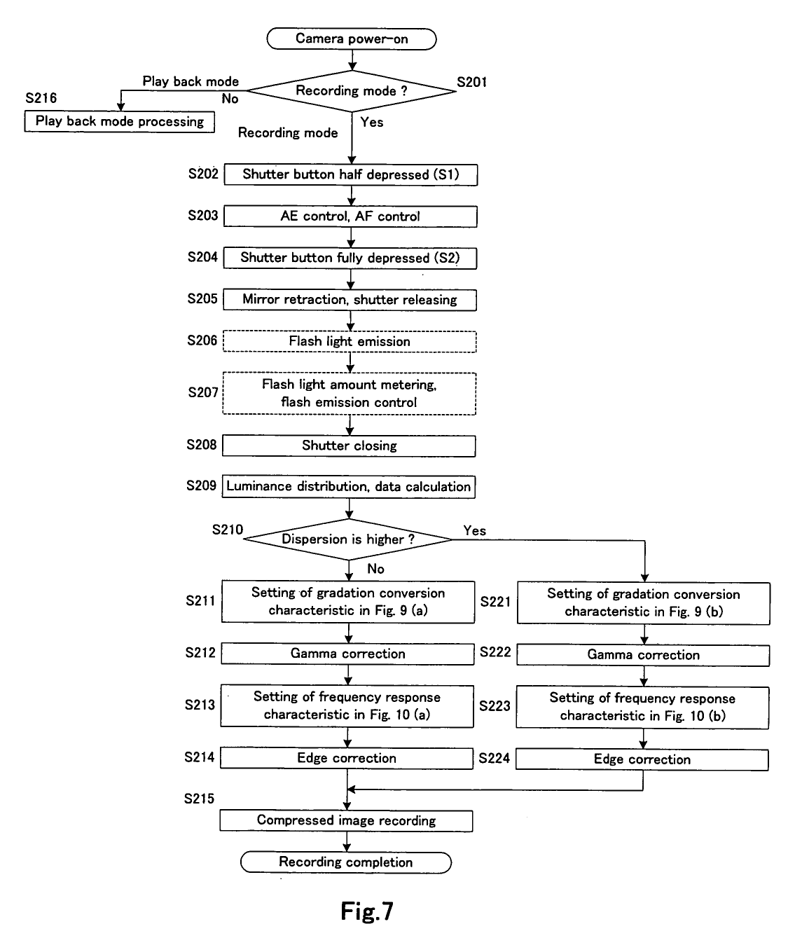

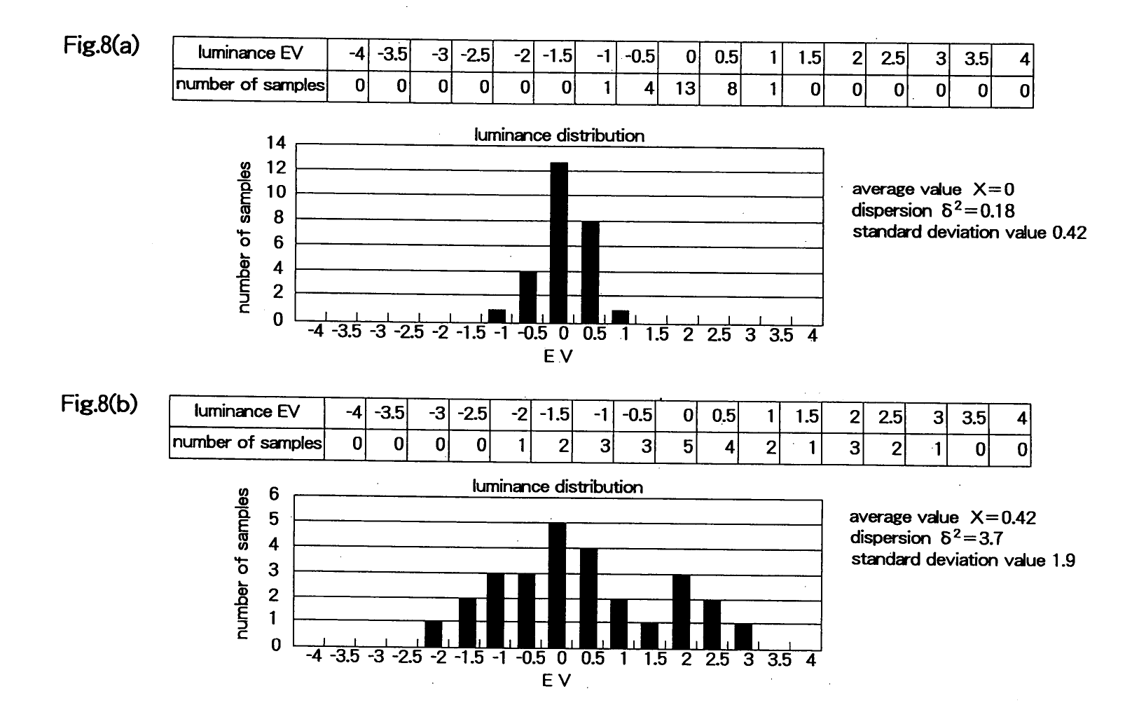

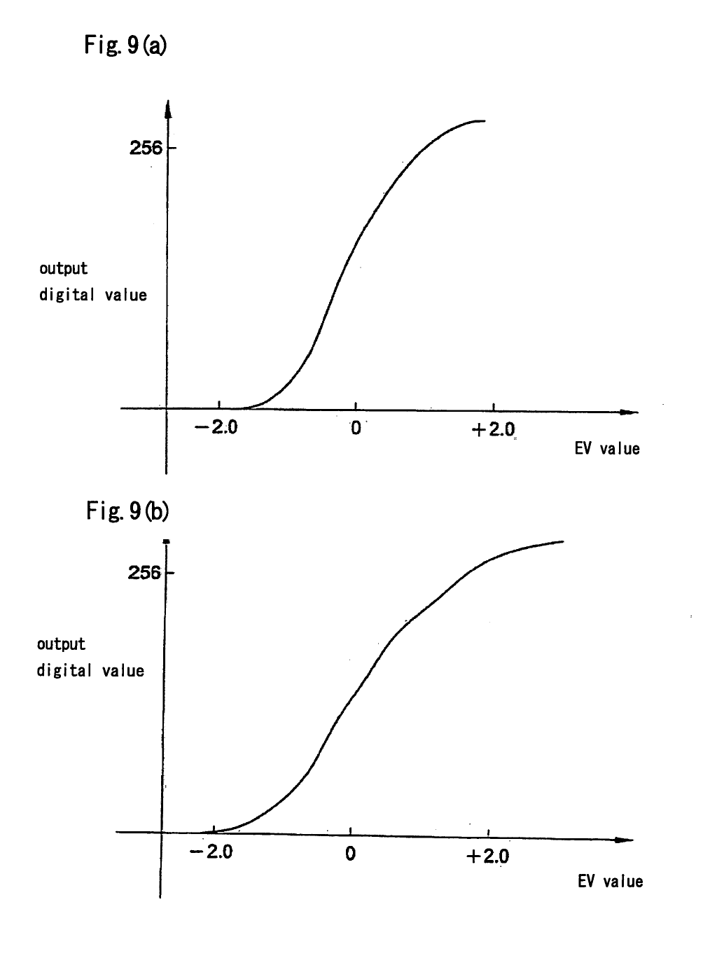

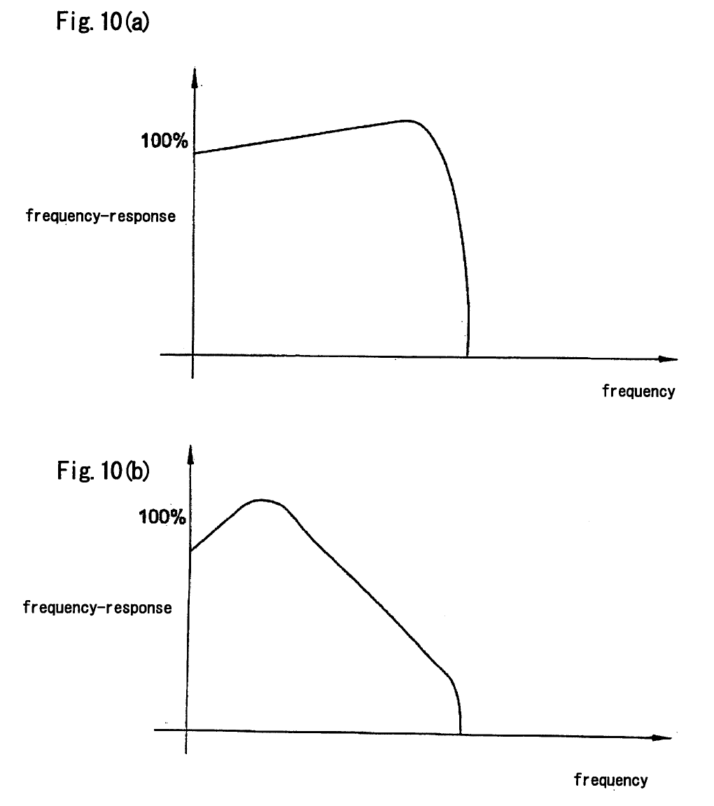

FIG. 7 is a flowchart explaining the setting procedure of the image processing performed by the image taking apparatus according to the present invention. FIGS. 8(a) and 8(b) are views explaining examples of the subject luminance distribution obtained by the sensor according to the present invention. FIGS. 9(a) and 9(b) are views explaining an example of a gradation conversion characteristic carried out according to the subject luminance distribution in the present invention. FIGS. 10(a) and 10(b) are views explaining an example of the frequency response characteristic carried out according to the subject luminance distribution in the present invention. Hereinafter, FIGS. 8(a) and 8(b), 9(a) and 9(b), and 10(a) and 10(b) in addition to the flowchart shown in FIG. 7 will be described.

When the digital camera 1 is turned on, the CPU 70 performs initialization, and then, detects and determines the condition of the mode switch (step S201).

When the set mode is the playback mode (step S201; No), the processing of the playback mode is performed (step S216).

When the set mode is the image taking mode (step S201; Yes), the digital camera 1 enters the image taking standby state.

When the shutter button is half depressed (S1) (step S202), the AE controller 72 performs automatic exposure control according to the output of the metering sensor 41, and the AF controller 71 performs automatic focusing control according to the output of the distance measurement sensor 42. The CPU 70 records the digital value which is the output of the metering sensor 41 or the distance measurement sensor 42 onto the RAM 75 (step S203).

When the shutter button is fully depressed (S2) (step S204), the CPU 70 starts the image taking sequence, sends an instruction to the mirror driver 91 at a predetermined timing to retract the mirrors 34a and 34b from the optical path of the taking lens 3, and sends an instruction to the shutter driver 93 to release the shutter 51 for a predetermined time (step S205).

In the case of flash image taking, at the next step, the CPU 70 fire the flash (step S206). The flash light amount metering sensor 43 meters the reflected light, of the flash light, from the subject, and when the exposure amount becomes a predetermined amount, the CPU 70 stops the light emission of the flash 94. Moreover, the CPU 70 records the output data of the flash light amount metering sensor 43 onto the RAM 75 (step S207).

When flash image taking is not performed, steps S206 and S207 are skipped, and the process proceeds to step S208.

When a predetermined exposure time has elapsed, the CPU 70 sends an instruction to the shutter driver 93 to close the shutter 51, and sends an instruction to the mirror driver 91 to return the mirrors 34a and 34b to predetermined conditions (step S208).

The CPU 70 obtains the subject luminance distribution data from the outputs of a plurality of photoelectric conversion areas (metering areas) of the metering sensor 41, the distance measurement sensor 42 or the flash light amount metering sensor 43 which outputs are recorded on the RAM 75, and calculates dispersion (step S209).

The dispersion σ² is obtained by the following calculation:

When the number of metering areas is n, the representative luminance value obtained from each metering block is Bi, and the average value is X,

$$\begin{matrix}X = \frac{1}{n} {\sum }_{i = 1}^{n} Bi & [ Expression 1 ] \\ {σ}^{2} = \frac{1}{n - 1} {\sum }_{n = 1}^{n} {( Bi - X )}^{2} & [ Expression 2 ]\end{matrix}$$

FIGS. 8(a) and 8(b) show examples of the luminance distribution obtained by the metering sensor 41 having the twenty-seven metering areas shown in FIG. 6. FIG. 8(a) shows an example of the data obtained when the dispersion σ² of the luminance distribution is low, and FIG. 8(b) shows an example of the data obtained when the dispersion σ² is high.

The upper table in FIG. 8(a) is a table of the luminance data obtained by the metering sensor 41. This example indicates that the metering areas of EV0 are thirteen of the twenty-seven metering areas and the metering areas of EV-0.5 are four of the twenty-seven metering areas. The lower graph is a plot of the upper table, and shows the luminance distribution. In this data, the subject luminance is distributed in a narrow range of −1 to 1 EV, and the dispersion σ² is low. In this example, the average value X is 0 EV, and the dispersion σ² is 0.18.

The upper table in FIG. 8(b) is also a table of the luminance data obtained by the metering data 41, and the lower graph is a plot of the upper table. In this data, the subject luminance is distributed in a wide range of −2 to 3 EV, and the dispersion σ² is high. In this example, the average value X is 0.42 EV, and the dispersion σ² is 3.7.

While description is given with the metering sensor 41 as an example in this specification, the dispersion can be similarly obtained when a distance measurement sensor 42 or a flash light amount metering sensor 43 is used that has a plurality of photoelectrical conversion areas different from those of the present example.

The CPU 70 determines whether the obtained dispersion σ² is higher or lower than a predetermined value (step S210).

When the dispersion σ² is lower (step S210; No), the process proceeds to step S211, and the CPU 70 sets the gradation conversion characteristic of the gamma corrector 221 as shown in FIG. 9(a) (step S211).

When the dispersion σ² is higher (step S210; Yes), the process proceeds to step S221, and the CPU 70 sets the gradation conversion characteristic of the gamma corrector 221 as shown in FIG. 9(b) (step S221).

FIGS. 9(a) and 9(b) are views explaining examples of the gradation conversion characteristic selected according to the dispersion of the luminance distribution. FIGS. 9(a) and 9(b) are double logarithmic charts, and the inclination of the input and output characteristic is the gamma value. The horizontal axes of FIGS. 9(a) and 9(b) represent the EV value obtained by converting the digital value of the taken image inputted from the A/D converter, to the subject luminance, and the vertical axes thereof represent the outputted digital value.

FIG. 9(a) shows an example of the gradation conversion characteristic applied when the dispersion of the luminance distribution of the subject is low as shown in FIG. 8(a).

When the dispersion of the subject luminance is low, that is, when the contrast is low, the gamma value is set to a high value so that the gradation can be reproduced at as high a contrast as possible. That is, in the example of FIG. 8(a), since the subject luminance is distributed in a narrow range of −1 Ev to +1 EV with respect to 0 EV, the inclination of the input and output characteristic is made steep so that the luminance distribution in the narrow range can be reproduced by making the utmost use of 256 gradations. For example, the gamma value is 0.7.

FIG. 9(b) shows an example of the gradation conversion characteristic applied when the dispersion of the luminance distribution of the subject is high as shown in FIG. 8(b).

When the dispersion of the subject luminance is high, that is, when the contrast is high, the gamma value is set to a low value so that the gradation can be reproduced as richly as possible. That is, in the example of FIG. 8(b), since the subject luminance is distributed in a wide range of −2 Ev to +3 EV with respect to 0 EV, the inclination of the input and output characteristic is made gentle so that the input in the wide range can be reproduced in the range of 256 gradations. For example, the gamma value is 0.4.

Based on the gradation conversion characteristic set in this manner, the gamma corrector 221 performs gamma correction (steps S212 and S222).

When the dispersion σ² is low (step S210; No), the process proceeds to step S213 following steps S211 and S212, and the CPU 70 sets the frequency response characteristic of the edge corrector as shown in FIG. 10(a) (step S213).

When the dispersion σ² is high (step S210; Yes), the process proceeds to step S223 following steps S221 and S222, and the CPU 70 sets the frequency response characteristic of the edge corrector as shown in FIG. 10(b) (step S223).

FIGS. 10(a) and 10(b) are views explaining examples of the frequency response characteristic selected according to the dispersion of the luminance distribution. The horizontal axes of FIGS. 10(a) and 10(b) represent the spatial frequency of the taken image, and the vertical axes thereof represent the output response.

FIG. 10(a) shows an example of the frequency response characteristic applied when the dispersion of the luminance distribution of the subject is low as shown in FIG. 8(a).

When the dispersion of the subject luminance is low, that is, the contrast is low, the high-frequency response of the frequency response is set to be high so that the edge is enhanced as much as possible in the reproduction. That is, like the example of FIG. 10(a), the response of high frequencies is made higher than that of the low-frequency region.

FIG. 10(b) shows an example of the frequency response characteristic applied when the dispersion of the luminance distribution of the subject is high as shown in FIG. 8(b).

When the dispersion of the subject luminance is high, that is, the contrast is high, the high-frequency response of the frequency response is set to be low since the image is unnatural if the edge is enhanced too much. That is, like the example of FIG. 10(b), the response of high frequencies is made lower than that of the low-frequency region.

Based on the frequency response characteristic set in this manner, the edge corrector 222 performs edge correction (steps S214 and S224).

Then, the image compressor 223 compresses the image. The compressed data is temporarily stored in the image memory 23, and then, successively recorded onto the memory card 25 (step S215).

As described above, according to the present embodiment, since the luminance distribution information of the subject is obtained by the sensor having a plurality of photoelectric converters and the optimum image processing of the taken image data according to the luminance distribution of the subject is performed, high-image-quality image taking according to the luminance distribution of the subject can be performed, and an image taking apparatus can be provided with which good-quality image taking can be performed even when the user does not have any special image taking skill.

Moreover, by using this image taking apparatus, a low-cost, small-size and high-image-quality digital camera can be provided.

While a digital single-lens reflex camera is shown as the embodiment, the present invention is applicable to digital cameras other than single-lens reflex cameras, mobile telephones and video cameras. While the metering of the fixed light is by the TTL method and the metering of the flash light amount is by the image taking plane metering method in the embodiment, the external metering method where the metering sensor is attached to the outside of the digital camera 1 is adoptable.

According to the present invention, the luminance distribution information of the subject in a wide range is obtained by the sensor having a plurality of photoelectrical converters, and for example, even when image taking is performed at a high shutter speed, the optimum image processing of the taken image data according to the luminance distribution of the subject can be performed. Consequently, an image taking apparatus and a digital camera with which high-quality images are obtained under any image taking environments can be provided.

The “dispersion information of the subject luminance distribution” in the image taking apparatus according to the present invention is information related to the dispersion condition of the luminance distribution of the subject obtained by the photoelectric conversion signal from the sensor.

According to the present invention, since the metering sensor for automatic exposure or the distance measurement sensor for automatic focusing can be used also as the sensor that photoelectrically converts the subject image, the effects of the present invention can be obtained without a sensor for photoelectric conversion being specifically provided. Consequently, the number of parts is reduced, so that an image taking apparatus can be provided with which high-quality images are obtained without any increase in the cost and the size of the apparatus.

According to the present invention, the gradation conversion setting of the taken image data can be performed from the luminance distribution of the subject obtained by the sensor, so that an image taking apparatus can be provided with which high-quality images having rich gradation reproducibility are obtained.

According to the present invention, by obtaining the set value from the luminance distribution of the subject obtained by the sensor and performing the frequency response setting of the taken image data, an image taking apparatus can be provided with which images with few noises and high sharpness are obtained.

According to the present invention, since the flash light amount is metered by the flash light amount metering sensor in flash image taking and the luminance distribution information of the subject is obtained, an image taking apparatus can be provided with which high-quality images are obtained also in flash image taking.

According to the present invention, since the gamma value of the taken image data is optimized according to the dispersion of the luminance distribution of the subject obtained by the sensor, an image taking apparatus can be provided with which high-quality images are obtained.

According to the present invention, since the frequency response of the taken image data is optimized according to the dispersion of the luminance distribution of the subject obtained by the sensor, an image taking apparatus can be provided with which high-quality images are obtained.

According to the present invention, a low-cost and small-size digital camera with which high-quality images are obtained can be provided.

According to the present invention, since the so-called single-lens reflex structure in which the luminous flux having passed through the lens barrel is directed toward the viewfinder before image taking is adopted, a digital camera can be provided that has an easy-to-view finder and with which high-quality images are obtained.

Although the present invention has been fully described by way of examples with reference to the accompanying drawings, it is to be noted here that various changes and modifications will be apparent to those skilled in the art. Therefore, unless otherwise such changes and modifications depart from the scope of the present invention, they should be construed as being included therein.

What is claimed is:

1. An image taking apparatus comprising:
a first sensor configured to photoelectrically convert a subject image for outputting an image data;
a second sensor configured to photoelectrically convert the subject image formed on the first sensor for outputting a photoelectric conversion signal, said second sensor having at least two photoelectric conversion areas that output the photoelectric conversion signal;
an image processor configured to process the image data from the first sensor with a predetermined input and output characteristic; and
a controller configured to set the input and output characteristic of the image processor based on dispersion information of a subject luminance distribution obtained from the photoelectric conversion signal from the second sensor.

2. The image taking apparatus as claimed in claim 1, wherein the second sensor is a metering sensor that obtains a subject luminance information.

3. The image taking apparatus as claimed in claim 1, wherein the second sensor is a distance measurement sensor that obtains a subject distance information.

4. The image taking apparatus as claimed in claim 1, wherein the input and output characteristic is a gradation conversion characteristic of the taken image data.

5. The image taking apparatus as claimed in claim 1, wherein the input and output characteristic is a frequency response characteristic of the taken image data.

6. The image taking apparatus as claimed in claim 1, further comprising:
an image taking optical system configured to direct a subject light onto the first sensor;
an optical finder configured so that the subject image formed by imaging the subject light is viewable by an operator; and
a light dividing member disposed between the image taking optical system and the first sensor, and movable between a first position for directing the subject light to the optical finder and a second position for being retracted from the subject light passed through the image taking optical system, said light dividing member dividing the subject light passed through the image taking optical system in order to direct the subject light to the optical finder and to the first sensor.

7. The image taking apparatus as claimed in claim 2, wherein the second sensor is a flash light amount metering sensor that meters a flash light amount upon a flash image taking.

8. The image taking apparatus as claimed in claim 2, wherein the second sensor photoelectrically converts the subject image divided into a plurality of metering blocks.

9. The image taking apparatus as claimed in claim 3, wherein the distance measurement sensor is formed by arranging a combination of line-type solid-state image sensors according to distance measurement areas.

10. The image taking apparatus as claimed in claim 3, wherein the distance measurement sensor is formed of area sensors.

11. The image taking apparatus as claimed in claim 3, wherein the distance measurement sensor includes a solid-state image sensor such as a CCD, a CMOS sensor or a CID sensor.

12. The image taking apparatus as claimed in claim 4, wherein a gamma value is set to a high value in the gradation conversion characteristic of the image data when the subject luminance distribution dispersion is low, and the gamma value is set to a low value in the gradation conversion characteristic of the image data when the subject luminance distribution dispersion is high.

13. The image taking apparatus as claimed in claim 5, wherein a high-frequency response in the frequency response characteristic is set to be high when the subject luminance distribution dispersion is low, and the high-frequency response in the frequency response characteristic is set to be low when the subject luminance distribution dispersion is high.

14. The image taking apparatus as claimed in claim 8, wherein each of the plural metering blocks is provided with a photoelectric conversion element such as a photodiode.

15. A digital camera comprising:
a first sensor configured to photoelectrically convert a subject image for outputting an image data;
a second sensor configured to photoelectrically convert the subject image formed on the first sensor for outputting a photoelectric conversion signal, said second sensor having at least two photoelectric conversion areas that output the photoelectric conversion signal;
an image processor configured to process the image data from the first sensor with a predetermined input and output characteristic; and
a controller configured to set the input and output characteristic of the image processor based on dispersion information of a subject luminance distribution obtained from the photoelectric conversion signal from the second sensor.

16. A method for processing of an image data of a subject in an image taking apparatus, said method comprising the steps of:
photoelectrically converting a subject image and outputting the image data by a first sensor;
photoelectrically converting the subject image formed on the first sensor and outputting a photoelectric conversion signal by a second sensor, said second sensor having at least two photoelectric conversion areas that output the photoelectric conversion signal; and
processing the image data from the first sensor with a predetermined input and output characteristic that is set based on dispersion information of a subject luminance distribution obtained from the photoelectric conversion signal from the second sensor.
